(19) United States
(12) Patent Application Publication
(10) Pub. No.: US 2020/0406932 A1
(43) Pub. Date: Dec. 31, 2020

(54) VEHICLE CONTROL DEVICE

(71) Applicant: Toyota Jidosha Kabushiki Kaisha, Toyota-shi (JP)

(72) Inventors: Yuchi Yamanouchi, Toyota-shi (JP); Masaki Shitara, Nagakute-shi (JP); Ryo Hattori, Kariya-shi (JP)

(21) Appl. No.: 16/909,181

(22) Filed: Jun. 23, 2020

(30) Foreign Application Priority Data
Jun. 28, 2019 (JP) 2019-121674

(51) Int. Cl. B60W 60/00; B60W 30/18; B60W 50/08

(52) U.S. Cl. CPC B60W 60/0025; B60W 30/18009; B60W 2540/00; B60W 60/007; B60W 50/085

(57) ABSTRACT

An automatic driving vehicle includes a mechanical emergency stop button for operation by an operator. When the operator presses the emergency stop button while the automatic driving vehicle is running in an automatic driving mode, the automatic driving vehicle stops running. The automatic driving vehicle has a touch panel for operation by the operator, the touch panel being provided forward of the emergency stop button. When the operator presses a SLOW DOWN button while the automatic driving mode is running in the automatic driving mode, the automatic driving vehicle decelerates and thereafter continues running.

### CROSS REFERENCE TO RELATED APPLICATION

This application claims priority to Japanese Patent Application No. 2019-121674 filed on Jun. 28, 2019, which is incorporated herein by reference in its entirety including the specification, claims, drawings, and abstract.

### TECHNICAL FIELD

This disclosure relates to a vehicle control device to be mounted in an automatic driving vehicle.

### BACKGROUND

Conventionally, automatic driving vehicles capable of automatic driving have been known. Automatic driving means that drive control, including, for example, vehicle speed control or steering control, is at least partially executed by a computer. An automatic driving vehicle typically has a plurality of driving modes, including an automatic driving mode in which automatic driving is executed, and a manual driving mode in which an operator on board the automatic driving vehicle executes drive control.

JP 2018-124855A discloses an automatic driving vehicle having two manual operation switches for instructing stopping of the vehicle.

### SUMMARY

While an automatic driving vehicle is running in an automatic driving mode, an operator may want to instruct a change in speed of the vehicle, rather than stopping the vehicle. In a conventional vehicle having a brake pedal, however, the automatic driving mode will be released when the brake pedal is operated, and thereafter switched to operation by the operator. This switching setting is troublesome for the operator when wishing to continue driving in the automatic driving mode. The above-mentioned JP No. 2018-124855A, however, does not describe a switch for changing a vehicle speed. Note that “speed” mentioned here does not refer to “velocity”, which is a vector quantity, used in physics, but refers to “speed”, which is a scalar quantity, or the magnitude of the vector quantity. Speed may be referred to as vehicle speed here.

This disclosure discloses a vehicle control device that can readily reflect an operator's intention regarding running of a vehicle while maintaining an automatic driving mode.

A vehicle control device in this disclosure is a vehicle control device to be mounted in an automatic driving vehicle capable of running in an automatic driving mode, the vehicle control device including: a first operation device for stopping the automatic driving vehicle while the automatic driving vehicle is running in the automatic driving mode, in response to an operation made by an operator; and a second operation device for changing the speed of the automatic driving vehicle while the automatic driving vehicle is running in the automatic driving mode, in response to an operation made by the operator, and thereafter causing the automatic driving vehicle to continue running in the automatic driving mode.

In one embodiment of the vehicle control device in this disclosure, the second operation device may decelerate the automatic driving vehicle to a predetermined speed, and thereafter cause the automatic driving vehicle to continue running in the automatic driving mode while maintaining the speed decelerated.

In one embodiment of the vehicle control device in this disclosure, the first operation device may be a first button for receiving a pressing operation or a touch operation made by the operator, and the second operation device may be a second button for receiving a pressing operation or a touch operation made by the operator.

In one embodiment of the vehicle control device in this disclosure, the second button may be a button for causing the automatic driving vehicle to continue running in the automatic driving mode, without stopping the automatic driving vehicle, also in a case where the operator continues operation.

In one embodiment of the vehicle control device in this disclosure, the second button may be a button for decelerating the automatic driving vehicle to a speed in accordance with a number of times the second button is operated or a duration of an operation of the second button by the operator, and thereafter causing the automatic driving vehicle to continue running in the automatic driving mode while maintaining the speed decelerated.

In one embodiment of the vehicle control device in this disclosure, the second button may be a button for accelerating the automatic driving vehicle to a speed in accordance with the number of times the second button is operated or the duration of the operation of the second button by the operator, in response to an operation of the second button made by the operator while the automatic driving vehicle is running at the speed decelerated, and thereafter causing the automatic driving vehicle to continue running in the automatic driving mode while maintaining the speed accelerated.

In one embodiment of the vehicle control device in this disclosure, the first operation device may be an emergency stop button for urgently stopping the automatic driving vehicle in response to a pressing operation by the operator, and the second operation device may be a button provided on a touch panel, the button for decelerating the automatic driving vehicle to a predetermined speed in response to a pressing operation or a touch operation by the operator, and thereafter causing the automatic driving vehicle to continue running in the automatic driving mode while maintaining the speed decelerated.

In one embodiment of the vehicle control device in this disclosure, the automatic driving vehicle may be a vehicle having neither an acceleration pedal nor a brake pedal.

According to this disclosure, an operator can readily give instructions to stop a vehicle or to change the speed of a vehicle, while the vehicle continues running in the automatic driving mode.

### BRIEF DESCRIPTION OF DRAWINGS

Embodiment(s) of the present disclosure will be described based on the following figures, wherein:

FIG. 1 illustrates an external appearance of an automatic driving vehicle according to this embodiment;

FIG. 2 is a first perspective view of the interior of the cabin of the automatic driving vehicle according to this embodiment;

FIG. 3 is a second perspective view of the interior of the cabin of the automatic driving vehicle according to this embodiment;

FIG. 4 illustrates a screen of a touch panel displayed when the vehicle is stopped;

FIG. 5 illustrates a screen of a touch panel displayed when the vehicle is in an automatic running;

FIG. 6 is a schematic diagram illustrating a change in speed as time passes when an emergency stop button is operated;

FIG. 7 schematically illustrates a change in speed as time passes when a SLOW DOWN button is operated;

FIG. 8A is an example display of the SLOW DOWN button and a SPEED UP button;

FIG. 8B is an example display of the SLOW DOWN button and the SPEED UP button;

FIG. 8C is an example display of the SLOW DOWN button and the SPEED UP button;

FIG. 9 schematically illustrates a change in speed as time passes when the SPEED UP button is operated; and

FIG. 10 illustrates another example screen of a touch panel displayed when a vehicle is running in automatic running.

### DESCRIPTION OF EMBODIMENTS

Embodiments will now be described while referring to the drawings. Although a specific aspect will be described below to help understanding of the embodiment, this is only for illustration of an example of an embodiment, and various other embodiments are possible.

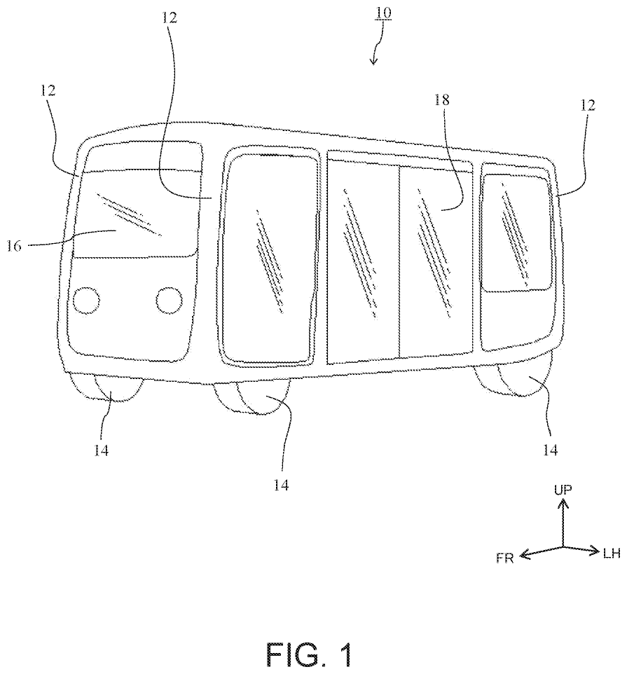

FIG. 1 illustrates an external appearance of an automatic driving vehicle 10 according to this embodiment. In the respective drawings attached to this specification, terms “front (FR)” and “rear” mean front and rear in the front-rear direction of the vehicle; terms “left (LH)” and “right” mean left and right when facing forward; and terms “up (UP)” and “down” mean up and down in the up-down direction of the vehicle.

The automatic driving vehicle 10 is shaped like a substantial rectangular parallelepiped that is front-rear symmetrical, and has an external design that is also front-rear symmetrical. The automatic driving vehicle 10 has pillars 12 extending in the up-down direction, disposed at four respective corners in a plan view. Below each pillar 12, a wheel 14 is mounted. A large part of each of the front, rear, right, and left side walls of the automatic driving vehicle 10 is made using semi-transparent panels 16. The panel 16 may be a display panel, where letters or the like may be displayed.

A panel in a part of the left surface constitutes a slidable door 18. The door 18 slides to open so that an occupant can get on or off the vehicle. An extendable ramp is stored below the door 18, but is not illustrated in FIG. 1. The ramp is used, for example, for an occupant in a wheelchair to get on or off the vehicle.

The automatic driving vehicle 10 is a vehicle capable of automatic driving. Specifically, the automatic driving vehicle 10 can be driven in a plurality of driving modes, including an automatic driving mode and a manual driving mode. In this embodiment, the automatic driving mode includes a control mode for control by a management center and a control mode for control by the automatic driving vehicle 10.

An automatic driving mode is a driving mode in which drive control is executed mainly by a computer. In this specification, drive control is a concept encompassing gear shift control, vehicle speed control, and steering control. Vehicle speed control is a concept encompassing launch control, stop control, and acceleration/deceleration control of the automatic driving vehicle 10.

Of the automatic driving modes, the control mode for control by a management center is a mode in which drive control is executed by a computer mounted in the automatic driving vehicle 10 in response to a driving instruction from the management center. The management center is available to manage and control a plurality of automatic driving vehicles 10, and can communicate with the respective automatic driving vehicles 10. In the control mode for control by the management center, the running route of the automatic driving vehicle 10 is determined according to an instruction from the management center. Drive control by a computer in the automatic driving vehicle 10 is executed largely according to an instruction from the management center. In this embodiment, however, launch control for launching a vehicle in a stopped state is executed in response to an instruction by means of an operation of an operator on board the automatic driving vehicle 10.

Of the automatic driving modes, the control mode for control by the automatic driving vehicle 10 is a driving mode in which, in principle, a majority of the drive control of the automatic driving vehicle 10 is executed based on determinations by a computer mounted in the automatic driving vehicle 10, without receiving an instruction from outside. Meanwhile, in the control mode for control by the automatic driving vehicle 10 in this embodiment, the computer in the automatic driving vehicle 10 executes drive control, based on the results of detections by various sensors (for example, a camera, a lidar, or the like) mounted in the automatic driving vehicle 10, without receiving an instruction from the management center, so that the automatic driving vehicle 10 runs along a predetermined route. Only, launch control for launching the vehicle in a stopped state is executed in response to an instruction by means of an operation of the operator on board the automatic driving vehicle 10.

A manual driving mode is a mode in which automatic driving of the automatic driving vehicle 10 is not executed, but drive control of the automatic driving vehicle 10 is executed by the operator on board the automatic driving vehicle 10.

The operator here refers to a person who is on board the automatic driving vehicle 10 and is involved in control of the automatic driving vehicle 10. In the automatic driving mode, in which drive control is executed mainly by the management center or the automatic driving vehicle 10 itself, the operator has few occasions to execute drive control. Nevertheless, the operator is involved in launching control for launching the vehicle in a stopped state and retains control, for example, for deceleration control or the like, to be described later, and thus can be considered to be involved in control of the automatic driving vehicle 10. Meanwhile, in the manual driving mode, the operator serves as a driver who drives the automatic driving vehicle 10 in person, and thus can be considered to be involved in control of the automatic driving vehicle 10.

The automatic driving vehicle 10 is a bus in which many unspecified occupants ride. In this embodiment, the automatic driving vehicle 10 is utilized as a bus that runs along a predetermined route within a specified site to transport passengers. Thus, the automatic driving vehicle 10 is expected to repeat stop and launch at a relatively high frequency. In addition, the automatic driving vehicle 10 is expected to run at a relatively slow speed (for example, slower than 30 km/h).

However, the form of use of the automatic driving vehicle 10 disclosed in this specification is arbitrarily changeable. For example, the automatic driving vehicle 10 can be utilized as a mobile business space, a sales outlet that displays and sells various products, or an eating outlet that serves cooked foods and drinks. Alternatively, as another form, the automatic driving vehicle 10 can be used as an office where people do office work or have a meeting with clients. Occasions on which the automatic driving vehicle 10 is utilized are not limited to business scenes, but the automatic driving vehicle 10 may be used, for example, as a private transportation means. In addition, the running pattern and running speed of the automatic driving vehicle 10 can be arbitrarily changed.

The automatic driving vehicle 10 is an electric vehicle including a drive motor that receives electric power from a battery, as a motor. The battery is a chargeable and dischargeable secondary battery, and is regularly charged with power from an outside source. The automatic driving vehicle 10, however, is not limited to an electric vehicle, and may be a vehicle of any other type. For example, the automatic driving vehicle 10 may be an engine vehicle having an engine as a motor, or a hybrid vehicle having an engine and a drive motor as motors. Alternatively, the automatic driving vehicle 10 may be a hydrogen vehicle that drives a drive motor with electric power generated by a fuel cell.

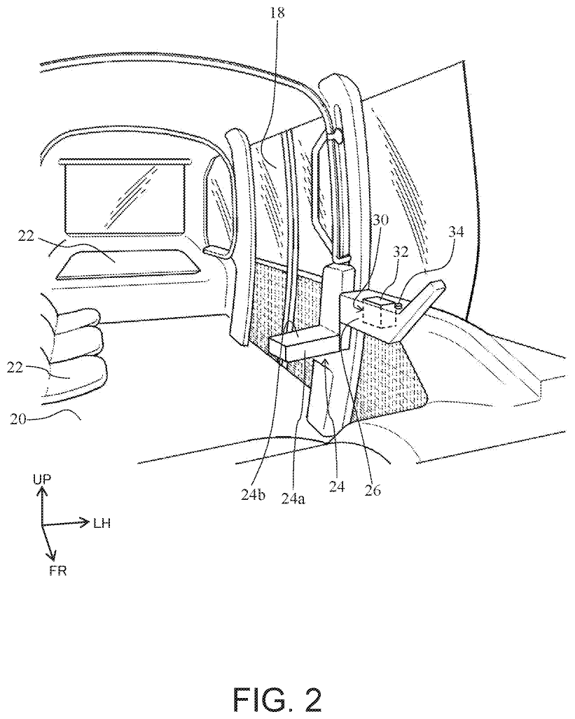

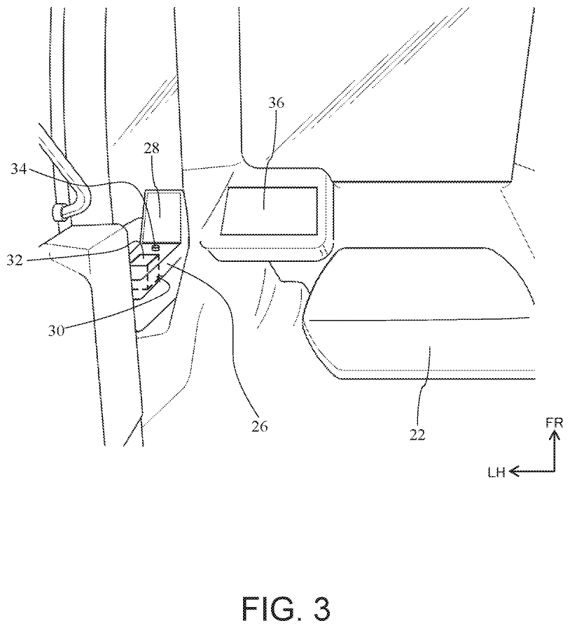

FIG. 2 and FIG. 3 are perspective views of the interior of the cabin of the automatic driving vehicle 10. As the automatic driving vehicle 10 is used as a bus, as described above, an area in the middle of the cabin serves as a floor 20 where occupants stand or where a wheelchair with an occupant sitting therein is placed. Along the side wall in the cabin, seats 22 for occupants are provided.

The automatic driving vehicle 10 includes an operator seat 24 for an operator responsible for drive control of the automatic driving vehicle 10 and operation of respective instruments (for example, an air conditioner, a wiper, or the like) installed in the automatic driving vehicle 10. In FIG. 2, a seat portion 24a of the operator seat 24 is flipped down such that a seat bottom 24b is seen. The seat portion 24a can be flipped up. Although the operator seat 24 is provided on the left surface and forward of the door 18 in the cabin, the operator seat 24 may be provided on the right surface of the cabin.

Forward of the operator seat 24, an armrest 26 long in the front-rear direction is provided for the operator sitting on the operator seat 24 to place his/her arm thereon. As the operator seat 24 is provided on the left surface inside the cabin in this embodiment, as described above, the armrest 26 as well is disposed in the left end area in the cabin. If the operator seat 24 is provided on the right surface inside the cabin, the armrest 26 as well is disposed in the right end area in the cabin. The armrest 26 is provided at a position higher than the seat bottom 24b of the operator seat 24 in a condition that allows the operator to sit thereon.

On the front end portion of the armrest 26, a touch panel 28 is provided standing upward from the upper surface of the armrest 26 (refer to FIG. 3). As the touch panel 28 is directed rearward (that is, toward the operator seat 24), the operator can operate the touch panel 28 with his/her finger while sitting on the operator seat 24 and having his/her arm resting on the armrest 26. Using the touch panel 28, input of a vehicle speed control instruction in the automatic driving mode and an instrument control instruction relative to the instruments (for example, a turn signal, a horn, a headlight, an air conditioner, a wiper, or the like) installed in the automatic driving vehicle 10 is possible. Details on the display screen of the touch panel 28 will be described later.

The armrest 26 includes a storage unit 30 for storing a mechanical operation unit for inputting a drive control instruction in relation to the automatic driving vehicle 10. The storage unit 30 is covered with a lid 32 so that the mechanical operation unit stored in the storage unit 30 is not exposed to the interior of the cabin. In this embodiment, the upper surface of the armrest 26 is flush with the lid 32. Although the storage unit 30 is provided to the armrest 26 in this embodiment, the storage unit 30 may be provided in a place other than the armrest 26. In this case as well, in some embodiments, the storage unit 30 is provided in an indistinctive place, for example, at an end portion on any of the front, rear, right, and left sides in the cabin. The mechanical operation unit is pulled out from the storage unit 30 mainly when the driving mode of the automatic driving vehicle 10 is the manual driving mode. When the driving mode of the automatic driving vehicle 10 is the automatic driving mode, the mechanical operation unit is normally stored in the storage unit 30 in order to prevent erroneous operation of the mechanical operation unit.

Further, a mechanical emergency stop button 34 is provided on the upper surface of the armrest 26 to manually input an emergent stop instruction in relation to the automatic driving vehicle 10. The mechanical button here refers to an actually existing physical button, rather than a button to be displayed on the touch panel 28 or the like by means of a program. When the operator presses the emergency stop button 34, the emergency stop button 34 transmits an electrical signal obtained in conversion to the drive control device.

Note that the mechanical emergency stop button 34 is an example of a first operation device that receives a pressing operation by the operator. As a first operation device, for example, a mechanical lever or a button displayed on the touch panel 28 (which receives a pressing operation or a touch operation by the operator) may be employed rather than the emergency stop button 34. Further, as a first operation device, a device for instructing a normal stop rather than an emergent stop may be employed.

As operation devices for inputting a vehicle speed control instruction in relation to the automatic driving vehicle 10, the automatic driving vehicle 10 includes only three operation devices; namely, the touch panel 28, the mechanical operation unit, and the emergency stop button 34. That is, the automatic driving vehicle 10 does not include a foot pedal, such as an acceleration pedal or a brake pedal, like those provided in conventional automobiles, to be operated with a foot to input a vehicle speed control instruction.

A display 36 for displaying information on the automatic driving vehicle 10 is provided at the front left corner in the cabin (refer to FIG. 3). The display 36 displays information, such as, for example, the vehicle speed of the automatic driving vehicle 10, outside temperature, or the next bus stop. Similar to the touch panel 28, the display 36 as well is directed rearward, so that the touch panel 28 and the display 36 appear aligned to each other to an operator sitting on the operator seat. This allows the operator to visually check both the touch panel 28 and the display 36. The display 36 may be provided at the same level as that of the touch panel 28. Specifically, the touch panel 28 and the display 36 are disposed such that the upper end of the display 36 is positioned at the same level as that of the upper end of the touch panel 28, the lower end of the display 36 is positioned at the same level as that of the lower end of the touch panel 28, or the middle of the display 36 in the height direction is positioned at the same level as that of the touch panel 28 in the height direction.

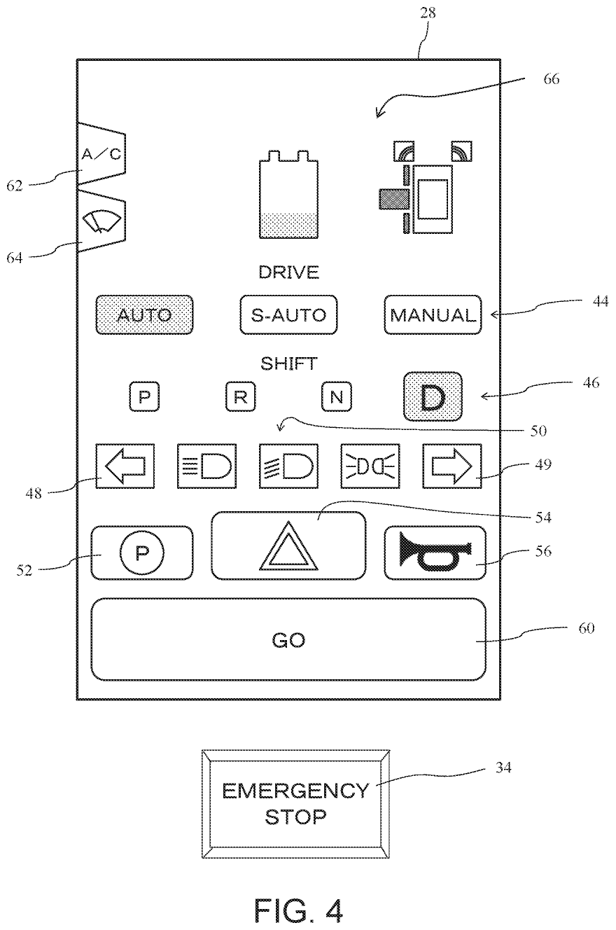

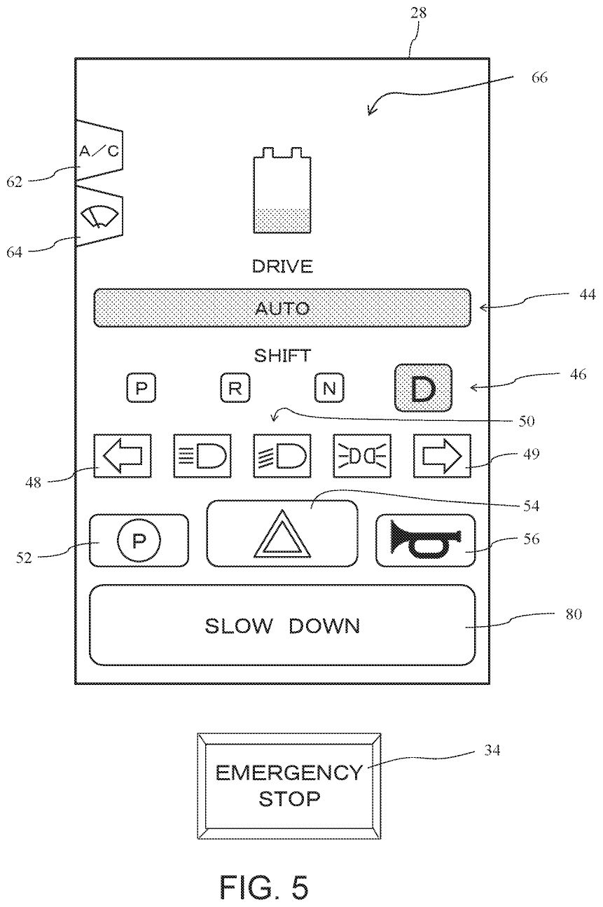

FIG. 4 and FIG. 5 illustrate a screen image displayed on the touch panel 28 and the emergency stop button 34 provided below the touch panel 28. FIG. 4 illustrates a display screen displayed with the automatic driving vehicle 10 stopped in the automatic driving mode, and FIG. 5 illustrates a display screen displayed with the automatic driving vehicle 10 running in the automatic driving mode.

Referring to FIG. 4, the touch panel 28 will be outlined. The touch panel 28 displays buttons, including a driving mode button 44 for inputting a driving mode change instruction, a shift button 46 for inputting a gear shift control instruction, turn signal buttons 48, 49 for controlling turn signals, light buttons 50 for controlling a headlight and a taillight, a P brake button 52 for inputting activation/release instruction relative to an automatic parking brake, a hazard button 54 for causing a hazard warning light to operate, a horn button 56 for causing a horn to operate, a GO button 60 for giving a launch instruction, an air conditioner tab 62 for controlling an air conditioner, and a wiper tab 64 for controlling a wiper. With the air conditioner tab 62 touched, various buttons for controlling the air conditioner appear. With the wiper tab 64 touched, various buttons for controlling the wiper appear. In an upper portion 66 of the touch panel 28, there are displayed the remaining amount of the battery of the automatic driving vehicle 10, the open/close state of the door 18, or the condition of the ramp, and detection states of various sensors provided to the automatic driving vehicle 10.

The driving mode buttons 44 are set operable only while the automatic driving vehicle 10 is stopped. The shift button 46 is set inoperable in the automatic driving mode in this embodiment, so that the operator cannot change gears in the automatic driving mode.

The GO button 60 is a button to be displayed on the touch panel 28 when the automatic driving vehicle 10 is stopped in the automatic driving mode. The GO button 60 is a button for inputting a launch instruction in relation to the automatic driving vehicle 10. That is, with the GO button 60 operated, the automatic driving vehicle 10 begins running (in the automatic driving mode in this case).

Referring to FIG. 5, the touch panel 28 to be displayed with the automatic driving vehicle 10 running in the automatic driving mode will be described. While the automatic driving vehicle 10 is running in the automatic driving mode, the touch panel 28 displays a SLOW DOWN button 80, instead of the GO button 60. The SLOW DOWN button 80 is a button for inputting a deceleration control instruction in relation to the automatic driving vehicle 10. That is, with the SLOW DOWN button 80 operated, the automatic driving vehicle 10 decelerates, and thereafter keeps running at the decelerated speed. The SLOW DOWN button 80 has a simple structure, and is capable of fine control to increase the magnitude of deceleration, depending on the number of times the SLOW DOWN button 80 is pressed or the duration of each pressing of the SLOW DOWN button 80. The SLOW DOWN button 80 is an example of a second operation device. As a second operation device, for example, a mechanical button may be employed, instead of a button to be displayed on the touch panel 28.

Change in speed of the automatic driving vehicle 10 as time passes when the emergency stop button 34 and the SLOW DOWN button 80 are operated will now be described.

### (1) Emergent Stop

While the automatic driving vehicle 10 is running in the automatic driving mode, an operator can urgently stop the automatic driving vehicle 10 by pressing the emergency stop button 34. For example, an operator may urgently stop the automatic driving vehicle 10, while attending to the surrounding situation of the automatic driving vehicle 10.

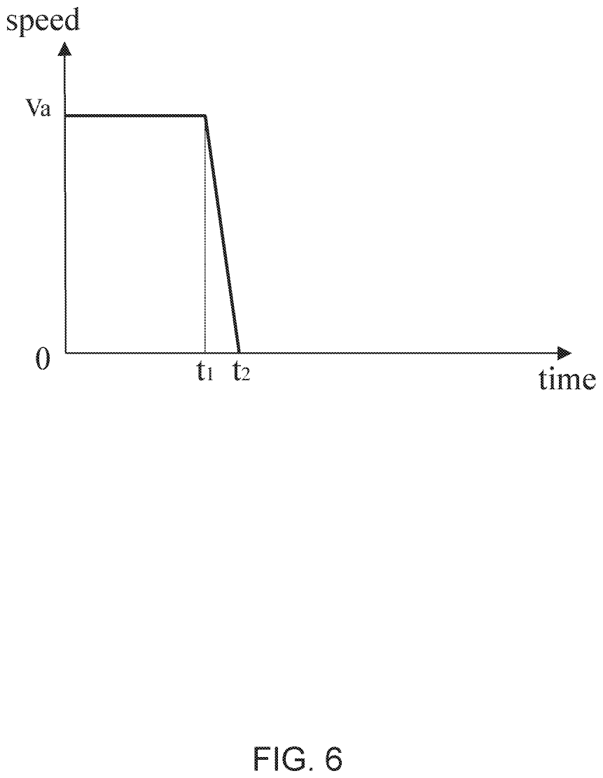

FIG. 6 schematically illustrate a change in speed of the automatic driving vehicle as time passes with the emergency stop button 34 pressed, in which the X-axis indicates time and the Y-axis indicates speed. In FIG. 6, the automatic driving vehicle 10 is assumed to run at the speed Va until time t1, at which the operator presses the emergency stop button 34. Consequently, the automatic driving vehicle 10 decelerates significantly during a short period of time to a speed zero, or the automatic driving vehicle 10 stops, at time t2. With the automatic driving vehicle 10 stopped, the GO button 60 is displayed again instead of the SLOW DOWN button 80, as illustrated in FIG. 4.

### (2) Deceleration

While the automatic driving vehicle 10 is running in the automatic driving mode, the operator can decelerate the automatic driving vehicle 10 by pressing the SLOW DOWN button 80. For example, the SLOW DOWN button 80, which allows the operator to have the automatic driving vehicle 10 running at a lower speed, rather than stopped, is usable, for example, when the automatic driving vehicle 10 is running in an area with a nice view, when any suspicious object or person is found in the vicinity, when danger is expected in the vicinity, or the like.

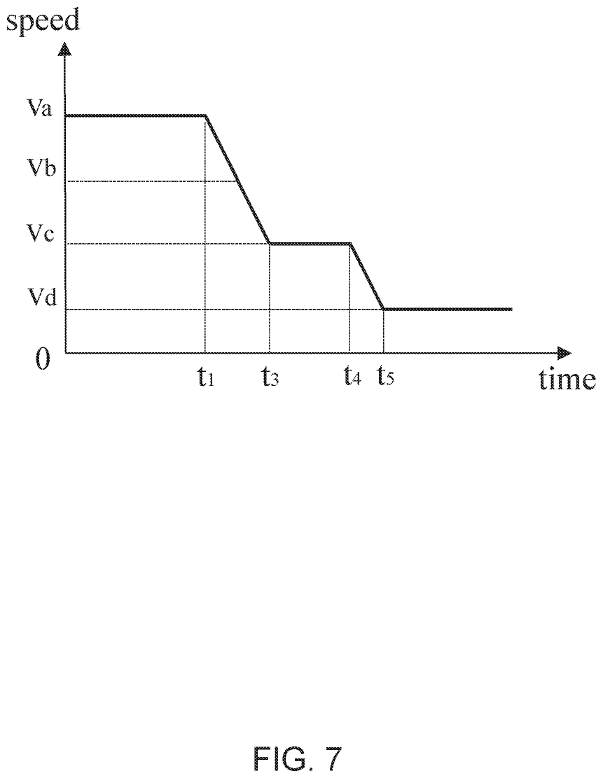

FIG. 7 schematically illustrates a change in speed of the automatic driving vehicle 10 as time passes when the SLOW DOWN button 80 is pressed, in which the X-axis indicates time, and the Y-axis indicates speed. In FIG. 7, the automatic driving vehicle 10 is assumed to run at the speed Va until time t1, at which the operator presses the SLOW DOWN button 80 twice during a short period of time. In this example, the SLOW DOWN button 80 is assumed to be set such that larger deceleration is made depending on the number of times the SLOW DOWN button 80 is pressed. Specifically, the automatic driving vehicle 10 decelerates from the speed Va to Vc (Va>Vc) during a period from time t1 to time t3. In the case where the SLOW DOWN button is pressed only once, deceleration is executed only from the speed Va to Vb (Va>Vb>Vc and Va-Vb being nearly equal to Vb-Vc). In the example illustrated in FIG. 7, as the SLOW DOWN button 80 is pressed twice, a twofold deceleration compared with that with the SLOW DOWN button 80 pressed once is executed.

After having reached the speed Vc at time t3, the automatic driving vehicle 10 continues running at the speed Vc. At time t4, the operator presses the SLOW DOWN button 80 once again. Thereupon, the automatic driving vehicle 10 decelerates to the speed Vd (Vc>Vd and Vb-Vc being nearly equal to Vc-Vd) by time t5 to thereafter continue running at the speed Vd.

In the example illustrated in FIG. 7, it is assumed that every pressing of the SLOW DOWN button 80 enables deceleration by the same deceleration amount (Va-Vb) until deceleration is made three times in total. This deceleration amount is only an example, and it may be the case that deceleration is allowed to be made only once or twice. Alternatively, deceleration may be allowed to be made four times or more in total. Each deceleration amount is not necessarily constant. For example, it may be set such that deceleration is executed by an amount in proportion to the speed at which the automatic driving vehicle 10 is running at the time. Specifically, every pressing of the SLOW DOWN button 80 may enable deceleration to a speed αVa, or a speed α times as fast as the original speed Va (0<α<1). In this case, pressing the SLOW DOWN button 80 twice leads to deceleration to the speed α²Va.

In this embodiment, the SLOW DOWN button 80 is assumed not to be a stop button. That is, in the example illustrated in FIG. 7, the speed Vd is the lowest speed set, and the automatic driving vehicle 10 cannot run at a speed lower than the speed Vd. In other words, pressing more the SLOW DOWN button 80 at time t5 or thereafter does not enable further deceleration. In addition, pressing the SLOW DOWN button 80 four or more times before time t1 does not enable deceleration of the automatic driving vehicle 10 to a speed lower than the speed Vd.

In the example illustrated in FIG. 7, the magnitude of deceleration is determined based on the number of times the SLOW DOWN button 80 is pressed. Alternatively, it is possible to set such that a longer duration of pressing the SLOW DOWN button 80 leads to a larger deceleration. For example, the duration T of pressing the SLOW DOWN button 80 is determined like a step function with an appropriate time interval, such as 0<T<0.5 seconds, 0.5<=T<1 second, or 1<T<1.5 seconds, to determine the amount of deceleration to be executed. Setting a very short time interval for the step function enables substantially stepless deceleration, depending on the duration T of pressing.

Deceleration with the SLOW DOWN button 80 can be executed in the automatic driving mode. For example, having the drive control device execute control based on conditions including an additional condition relevant to a deceleration instruction enables deceleration in the automatic driving mode. Then, the automatic driving vehicle 10 continues running at the decelerated speed in the automatic driving mode after completion of deceleration.

Alternatively, deceleration with the SLOW DOWN button 80 may be executed such that the manual driving mode is set only during deceleration. That is, in response to the SLOW DOWN button 80 being pressed, the drive control device releases the automatic driving mode to switch to drive control in the manual driving mode to execute deceleration in the manual driving mode. For example, when the mechanical operation unit is pulled out of the storage 30 and placed on the armrest 26 for use by the operator to give a manual driving instruction, the driving mode can be switched to the manual driving mode to temporarily assign drive control, including steering control, or the like, to the operator. As the SLOW DOWN button 80 is premised on continuation of running in the automatic driving mode, the driving mode will be automatically switched back to the automatic driving mode after completion of deceleration. This allows an operator to have the automatic driving vehicle 10 continue running in the automatic driving mode without explicitly switching to the automatic driving mode.

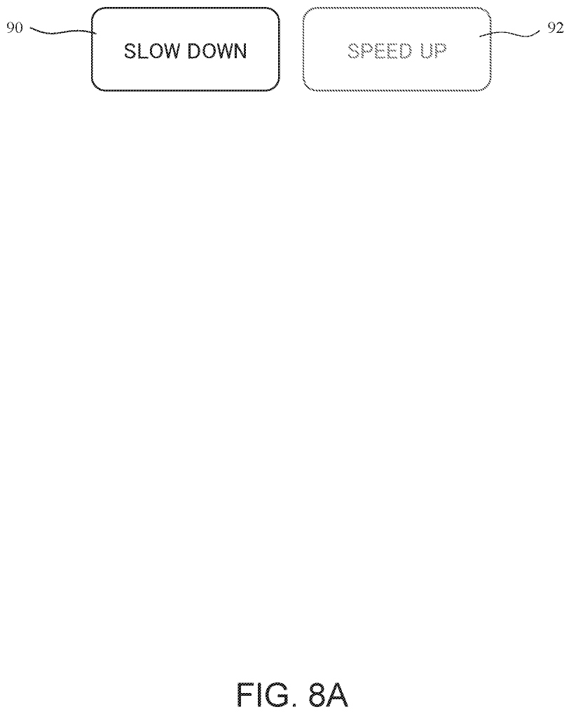

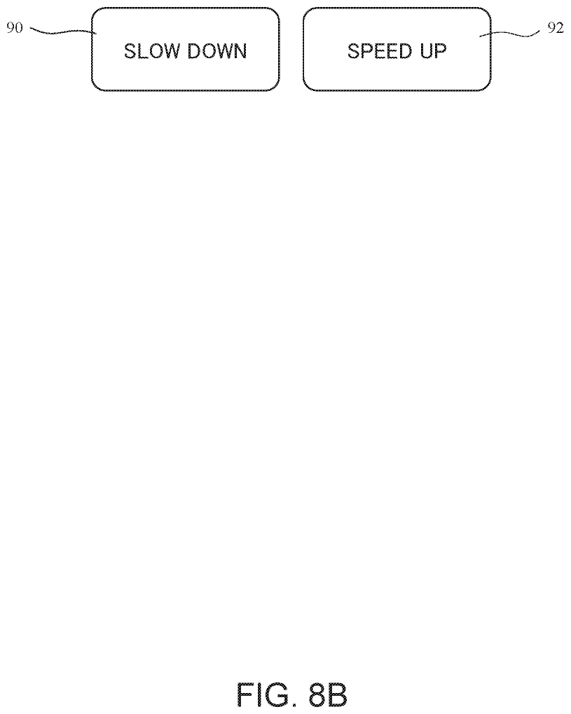

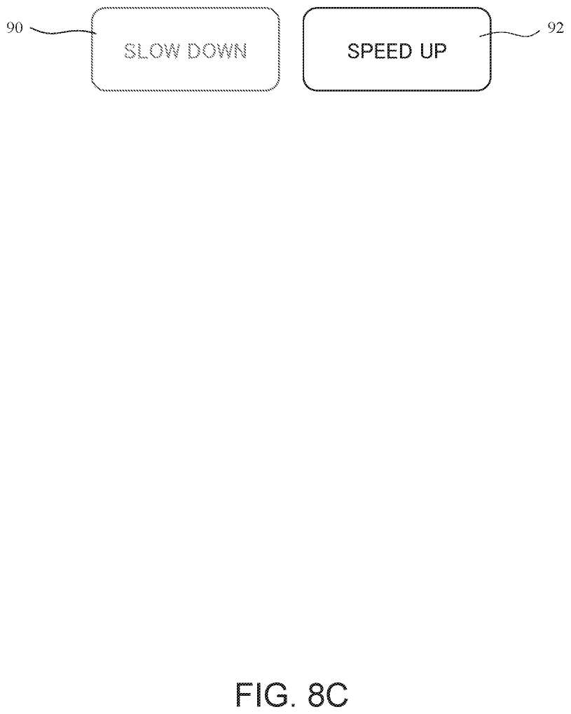

An aspect in which the decelerated speed is recovered to the original speed will now be described referring to FIG. 8A to FIG. 8C. FIG. 8A to FIG. 8C illustrate two adjacent buttons to be displayed instead of the SLOW DOWN button 80 on the touch panel 28, illustrated in FIG. 5. Specifically, a SLOW DOWN button 90 is disposed on the left side, while a SPEED UP button 92 is disposed on the right side.

FIG. 8A illustrates a display state with deceleration not executed; for example, a display state before time t1 in FIG. 7, in which the SLOW DOWN button 90 is distinctly displayed to be operable, and the SPEED UP button 92 is only dimly displayed (or not displayed) to be inoperable. Thus, in the example in FIG. 7, before time t1, it is only possible to press the SLOW DOWN button 90 to instruct deceleration, but not to press the SPEED UP button 92 to instruct acceleration.

FIG. 8B illustrates a display state with deceleration executed but without a deceleration instruction to the lowest speed; that is, for example, a display state from time t1 to time t4 in FIG. 7. In this state, both the SLOW DOWN button 90 and the SPEED UP button 92 are both distinctly displayed to be operable, so that the operator can instruct both deceleration and acceleration.

FIG. 8C illustrates a display state with a deceleration instruction to the lowest speed given; that is, for example, a display state after time t4 in FIG. 7. In this state, the SLOW DOWN button 90 is dimly displayed (or not displayed) to be inoperable, and the SPEED UP button 92 is distinctly displayed to be operable. Thus, the operator can instruct acceleration, but not deceleration.

Both the SLOW DOWN button 90 and the SPEED UP button 92 are examples of a second operation device. As a second operation device, for example, a mechanical button may be employed instead of a button to be displayed on the touch panel 28.

Change in speed of the automatic driving vehicle 10 as time passes with the SPEED UP button 92 operated under the respective settings in FIG. 8A to FIG. 8C will now be described.

### (3) Acceleration

While the automatic driving vehicle 10 is running in the automatic driving mode, the operator can accelerate the automatic driving vehicle 10 by pressing the SPEED UP button 92. Acceleration can be rephrased as cancellation of deceleration, or speed recovery toward a previous state.

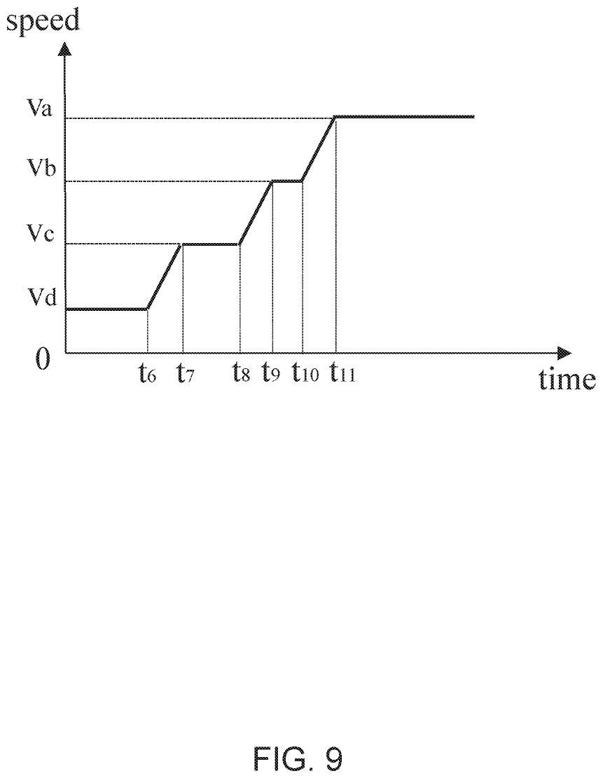

FIG. 9 schematically illustrates a change in speed of the automatic driving vehicle 10 as time passes, assuming a state after time t5 in FIG. 7, in which the X-axis indicates time and the Y-axis indicates speed. Before time t5, the SLOW DOWN button 90 is pressed with the speed Va, whereby the automatic driving vehicle 10 is decelerated to the speed Vd, and thereafter continues running at the speed Vd.

At time t6, the operator presses the SPEED UP button 92 once. Thereupon, the automatic driving vehicle 10 accelerates toward time t7, at which the speed reaches the speed Vc. The automatic driving vehicle 10 thereafter continues running at the speed Vc. Subsequently, the SPEED UP button 92 is pressed once at time t8, upon which the speed Vc is accelerated to the speed Vb by time t9. Further, the SPEED UP button 92 is pressed again at time t10, upon which the speed reaches the speed Va, or the speed same as that before time t1, by time tn.

As described above, similar to the above-described SPEED DOWN button 80, the SPEED UP button 92 as well enables stepwise acceleration depending on the number of times the SPEED UP button 92 is pressed. Also, similar to the SLOW DOWN button 80, acceleration may be executed in accordance with the duration of pressing of the SPEED UP button 92.

Similar to the SLOW DOWN button 80, the SPEED UP button 92 as well can be set such that acceleration control is executed in the automatic driving mode, and control in the automatic driving mode continues after completion of acceleration. Alternatively, the driving mode may be temporarily switched to the manual driving mode to execute acceleration once the SPEED UP button 92 is pressed, and then automatically switched to the automatic driving mode after completion of acceleration so that the automatic driving vehicle 10 thereafter continues running in the automatic driving mode.

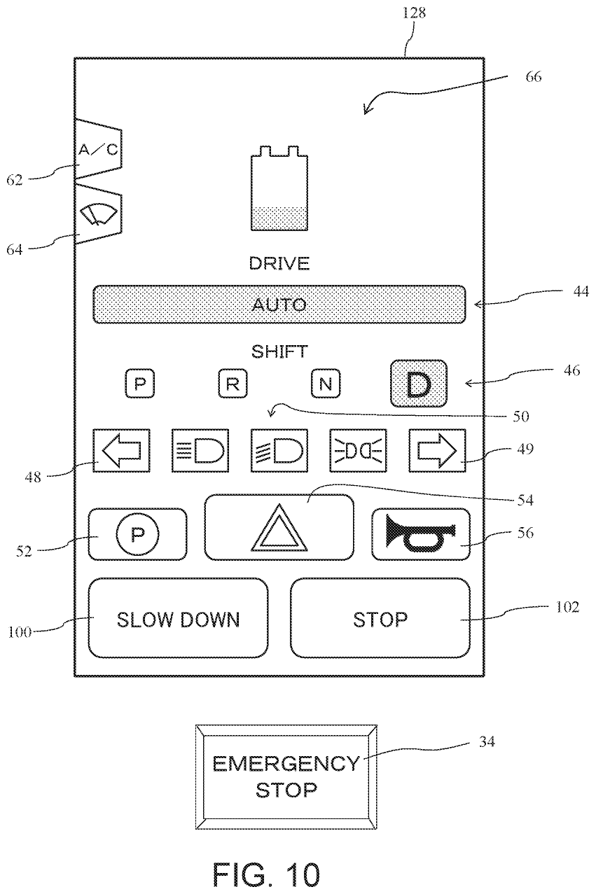

Finally, another embodiment will be described referring to FIG. 10. FIG. 10 illustrates a touch panel 128 corresponding to the touch panel 28 in FIG. 5. The touch panel 128 displays a SLOW DOWN button 100 and a STOP button 102, instead of the SLOW DOWN button 80 on the touch panel 28.

Similar to the above-described SLOW DOWN buttons 80, 90, the SLOW DOWN button 100 is a button that cannot have a vehicle run at a speed lower than the lowest speed; that is, a button not usable to instruct stopping of the vehicle. Meanwhile, the STOP button 102, which is an example of the first operation device, is a button usable to instruct stopping of the vehicle on a normal time scale. That is, with the STOP button 102 pressed, the automatic driving vehicle 10 does not decelerate sharply, different from a case with the emergency stop button 34 pressed, but decelerates relatively slowly (for example, deceleration as slowly as is with the SLOW DOWN button 100 pressed) to finally stop running. This allows the operator to instruct not only low-speed running but also a normal stop, not an emergent stop, while the automatic driving vehicle 10 is running in the automatic driving mode. With the STOP button 102 pressed, stop control may be executed in the automatic driving mode, and the automatic driving mode may be maintained after the automatic driving vehicle 10 stops. Alternatively, the driving mode may be switched to the manual driving mode to execute stop control, and then switched to the automatic driving mode after the automatic driving vehicle 10 stops. Restart of running in the automatic driving mode is instructed with a GO button 60 to be displayed on the touch panel 128. Note that, for an emergent stop, the operator presses the mechanical emergency stop button 34 below the touch panel 128.

The touch panel 128 may additionally display a SPEED UP button. That is, the touch panel 128 can display SLOW DOWN, SPEED UP, and STOP buttons to instruct deceleration, acceleration, and stopping, respectively. In this case, the operator can instruct deceleration, acceleration, and a normal stop via the touch panel 128 while the automatic driving vehicle 10 is running in the automatic driving mode, and also instruct an emergent stop with the emergency stop button 34.

In the case where a plurality of buttons are displayed on the touch panel 128, these buttons can be displayed in different colors, for example, so that an operator can readily recognize the buttons. With deceleration or acceleration instructed, a description of the control may be displayed in order to enhance predictability of control of the automatic driving vehicle 10 in response to the operation. Specifically, an aspect in which an indication of a target speed of acceleration or deceleration is displayed, such as “deceleration to X km/h”, and an aspect in which the amount of acceleration or deceleration is displayed, such as “speed down by X km/h”, are possible as examples.

1. A vehicle control device to be mounted in an automatic driving vehicle capable of running in an automatic driving mode, the vehicle control device comprising:
a first operation device for stopping the automatic driving vehicle while the automatic driving vehicle is running in the automatic driving mode, in response to an operation made by an operator; and
a second operation device for changing a speed of the automatic driving vehicle while the automatic driving vehicle is running in the automatic driving mode, in response to an operation made by the operator, and thereafter causing the automatic driving vehicle to continue running in the automatic driving mode.

2. The vehicle control device according to claim 1, wherein the second operation device decelerates the automatic driving vehicle to a predetermined speed, and thereafter causes the automatic driving vehicle to continue running in the automatic driving mode while maintaining the speed decelerated.

3. The vehicle control device according to claim 1, wherein
the first operation device is a first button for receiving a pressing operation or a touch operation made by the operator, and
the second operation device is a second button for receiving a pressing operation or a touch operation made by the operator.

4. The vehicle control device according to claim 3, wherein the second button is a button for causing the automatic driving vehicle to continue running in the automatic driving mode, without stopping the automatic driving vehicle, also in a case where the operator continues operation.

5. The vehicle control device according to claim 3, wherein the second button is a button for decelerating the automatic driving vehicle to a speed in accordance with a number of times the second button is operated or a duration of an operation of the second button by the operator, and thereafter causing the automatic driving vehicle to continue running in the automatic driving mode while maintaining the speed decelerated.

6. The vehicle control device according to claim 5, wherein the second button is a button for accelerating the automatic driving vehicle to a speed in accordance with a number of times the second button is operated or a duration of the operation of the second button by the operator, in response to an operation of the second button made by the operator while the automatic driving vehicle is running at the speed decelerated, and thereafter causing the automatic driving vehicle to continue running in the automatic driving mode while maintaining the speed accelerated.

7. The vehicle control device according to claim 1, wherein
the first operation device is an emergency stop button for urgently stopping the automatic driving vehicle in response to a pressing operation by the operator, and
the second operation device is a button provided on a touch panel, the button for decelerating the automatic driving vehicle to a predetermined speed in response to a pressing operation or a touch operation by the operator, and thereafter causing the automatic driving vehicle to continue running in the automatic driving mode while maintaining the speed decelerated.

8. The vehicle control device according to claim 1, wherein the automatic driving vehicle is a vehicle having neither an acceleration pedal nor a brake pedal.
